(19) United States
(12) Patent Application Publication
(10) Pub. No.: US 2011/0086707 A1
(43) Pub. Date: Apr. 14, 2011

(54) Transferable exercise video game system for use with fitness equipment

(76) Inventor: Rohan Christopher Loveland, Los Alamos, NM (US)

(21) Appl. No.: 12/925,117

(22) Filed: Oct. 13, 2010

Related U.S. Application Data
(60) Provisional application No. 61/251,089, filed on Oct. 13, 2009.

(51) Int. Cl. A63F 13/06; A63B 24/00

(52) U.S. Cl. 463/36; 482/4

(57) ABSTRACT

One embodiment of a wearable exergaming system comprised of control push-buttons and motion sensor worn by the player, communicating wirelessly with a portable computer/display placed on the fitness equipment in front of the player. This allows a fully portable exergaming system, that can be used on a number of different fitness machines, which is easily transferable from person to person and machine to machine. Other embodiments are described.

### CROSS-REFERENCE TO RELATED APPLICATIONS

This application claims the benefit of provisional patent application Ser. No. 61/251,089, filed 2009 Oct. 13 by the present inventor.

### BACKGROUND

### Prior Art

This application relates to the combination of fitness equipment (e.g. elliptical trainers, stationary bikes) with video-games, sometimes referred to as “exergames”.

The increasingly sedentary nature of both work and leisure activities have greatly contributed to the general worsening of public health and the obesity epidemic. The recognition of the importance of exercise has led to a number of attempts to make exercise both more fun and more convenient, through the development of exergaming systems. The exergame “Dance, Dance, Revolution” and the various Wii games (e.g. Wii Tennis) are some of the best known examples of successful exergames. This application is concerned with the subset of exergames involving fitness equipment, such as elliptical trainers and stationary bikes.

The first instance of an exergaming system known to the inventor dates back to 1982. A fan web-site of the now defunct Atari company explains that, “Sensing an opportunity to bring health fitness and videogames together, in 1982 Atari embarked on “Project Puffer,” a top-secret mission to develop a home exercise bike with two hand grip controllers, a wheel speed pickup, and the necessary attachments for an Atari computer or 5200. By interfacing their machines to an exercise bicycle, Atari planned to make exercising fun.

The Puffer featured hand controllers which easily attached to most existing exercise cycles and gave the conscientious user directional control. The act of peddling was to give the imaginary vehicle motion and the rider exercise. Therefore, no peddling—no motion. For the overzealous cyclist, a pulse rate sensor could be added to monitor excessive heart beat activity.

The two hand controllers replaced the original hand grips on the exercycle. The Puffer controllers were designed to fit as many of the current exercycles as possible while at the same time remaining inexpensive and durable. A magnet attached to the wheel monitored the wheel speed and a Hall effect sensor detected the passing magnet which can be read by the computer to calculate the wheel speed. The housing for the sensor was also the junction box for the hand controller cables and the computer cable. The computer required only one cable to be connected to a joystick input.”

U.S. patent application Ser. No. 11/433,066 of Addington, et. al, filed 2006 Dec. 21 is very similar to Puffer, comprising a video game controller and sensor that can be mounted on a variety of exercycles, etc. U.S. patent application Ser. No. 11/078,913 of Waters, filed 2006 Oct. 12 is also similar, though it also has the potential for use with a standard road bicycle. Finally, U.S. patent application Ser. No. 12/358,404 of Pryor also interfaces a video game with an exercise machine, but uses electro-optical sensors (e.g. cameras), to determine player motion, etc.

Beyond the interface systems that mount to existing fitness equipment, there are several exergaming systems in which the exercise machine is custom made for the system, and comprises an integral part of it. The GameBike systems sold by Source Distributors are meant to be used in place of the standard Nintendo game controller. The Expresso upright bike systems are also custom built machines allowing the user to ride through virtual scenery and play a limited video game. The recent Dogfighter systems integrate a recumbent bike with an aerial dogfighting game.

U.S. Pat. No. 5,362,069, of Hall-Tipping, issued 1994 Nov. 8, includes means for adjusting both the fitness equipment difficulty level and the difficulty level in the game play itself.

All of the previously mentioned systems require either the purchase of wholly new integrated exergaming fitness machines outright, or the mounting of special fixtures to individual fitness machines. The purchase of new exergaming machines fails to allow a gym owner to utilize his/her existing fitness machines, which represent a significant investment. Likewise, the mounting of special fixtures to individual machines requires a gym owner to choose which of his/her existing machines to refit as exergames, leaving the rest unusable as exergames. Retrofitting all existing machines, complete with computers and displays, is a costly solution.

The retrofitting process is also inherently more prone to failure due to the possibility that the untrained installer of the exergaming interface may fail to install it correctly. This potential complication may in turn affect the willingness of a potential user to purchase the exergaming interface in the first place.

There are no systems that are currently offered commercially, and none known in the art, that overcome the previously mentioned disadvantages by providing a wholly portable and easily transferable wearable exergaming system, as disclosed by this application.

### SUMMARY

This application describes a wearable exergaming system comprised of control push-buttons and motion sensor worn by the player, communicating wirelessly with a portable display placed on the fitness equipment in front of the player.

### Advantages

Accordingly several advantages of one or more aspects are as follows: to allow a fully portable exergaming system, that can be used on a number of different fitness machines, that is easily transferable from person to person and machine to machine, that is inexpensive, that is compact enough to work with any fitness machine without moving the machine or reconfiguring the space, that is low power and does not require an external power source, that is safer than alternatives because it has no cables to get tangled up in moving parts, and that does not require any installation. Other advantages of one or more aspects will be apparent from a consideration of the drawings and ensuing description.

### DRAWINGS

### Figures

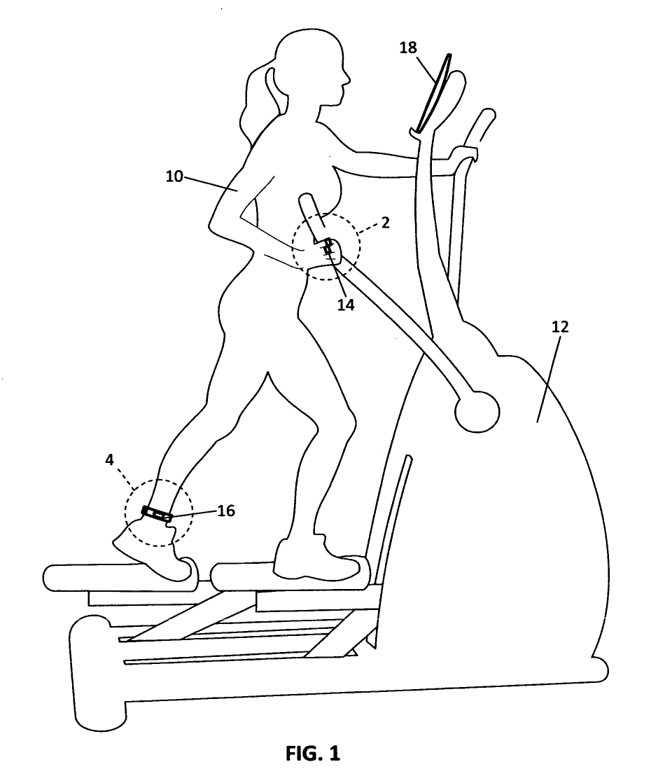

FIG. 1 shows one possible embodiment with a player wearing the interface playing an exergame on a portable “slate” computer placed on the magazine rack of an elliptical trainer.

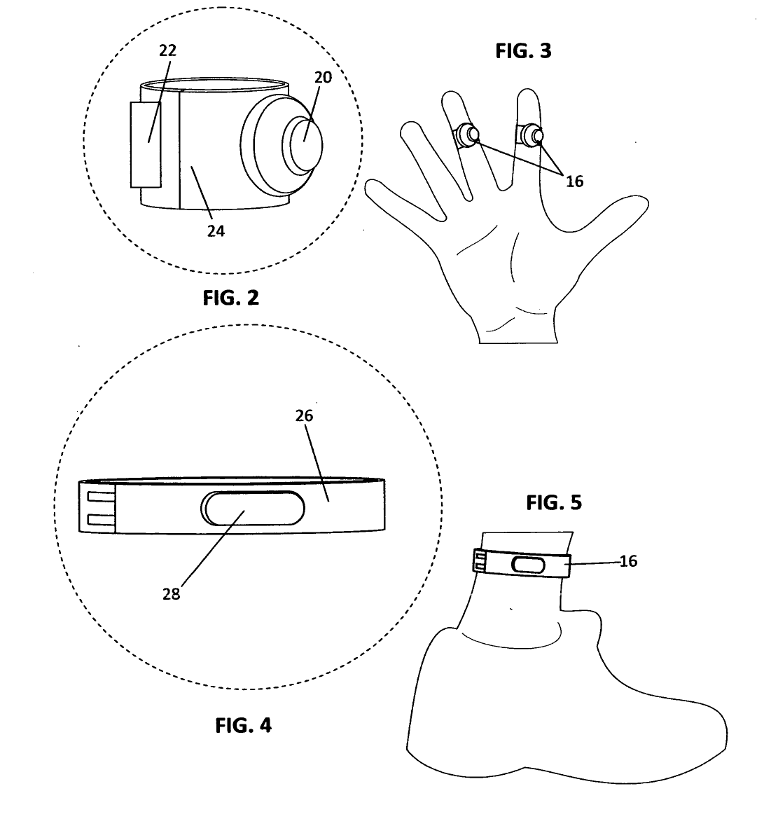

FIG. 2 shows an expanded view of a ring push-button control device.

FIG. 3 shows a ring push-button control device as it would be worn on a hand.

FIG. 4 shows an expanded view of a motion sensing device.

FIG. 5 shows a motion sensing device as it would be worn on a band around an ankle.

Drawings - Reference Numerals

| | | | |
|---|---|---|---|
| 10 | user | 12 | fitness machine |
| 14 | ring push-button control device | 16 | motion sensing device |
| 18 | slate computer | 20 | control push-button |
| 22 | wireless communication circuitry | 24 | removable ring band |
| 26 | removable ankle strap | 28 | motion device circuitry |

### DETAILED DESCRIPTION

### FIGS. 1 Through 5—Embodiments

One embodiment of the invention is illustrated in FIG. 1. A user 10 of the exergaming system is exercising on a fitness machine 12. He/she is wearing two ring push-button control devices 14 on each hand and a motion sensing device 16 on a removable ankle strap 26 around her ankle. The control push-buttons 20 are facing towards the inside, as illustrated in FIG. 3. This allows user 10 to grip the handles of fitness machine 12 in such a way as to hold on normally, and depress the control push-buttons 20 when desired.

The ring push-button control devices 14 and motion sensing device 16 are sending the state of the buttons and the quantities of motion to slate computer 18, which has a combined computer and display contained in a single compact package. (A current example of a popular slate computer is the iPad®.) Slate computer 18 is set on the magazine rack of fitness machine 12, allowing user 10 to play a video game running on it.

All of the components of the system are easily put on, removed, and transferred between fitness machines. Each ring push-button control device 14 has a removable ring band 24 which be embodied either as a Velcro strap or a flexible band with a small buckle. Removable ankle strap 26 can be fashioned similarly with Velcro or a flexible band, and worn loosely around the ankle. Slate computer 18 is likewise simply carried by user 10 to the fitness machine of his/her choice in order to convert any fitness machine to an exergaming system.

The communications between ring push-button control device 14, motion sensing device 16, and slate computer 18 are accomplished wirelessly, using Bluetooth®, Wireless USB, IEEE 802.11 (also known as Wi-Fi) or any of a wide variety of other standards. FIG. 2 shows an expanded view of ring push-button control device 14, with control push-button 20 on one side connected flexibly to wireless communication circuitry 22 on the other. FIG. 4 shows a similar expanded view of motion sensing device 16, where the motion device circuitry 28, consisting of sensor and communications circuitry, are integrated into a single small unit.

The specific details of the wireless communication circuitry will vary depending on the wireless standard chosen. A variety of off-the-shelf integrated circuit (IC) transceivers are currently available for the various standards; one example is Nordic's nRF24LU1+ system-on-chip wireless transceiver, which features a fully integrated USB 2.0 compliant device controller. The state of integration of these IC's is such that the circuitry can consist of a single chip, a few resistors and capacitors, and a watch battery. One example is from the Sparkfun Electronics company, which sells breakout board WRL-09034 for hobbyist usage for the USB 2.0 standard. A custom circuit board can be manufactured to be about the size of a dime, with the primary constraint on miniaturization being the size of the watch battery power source.

The control push-buttons 20 can be implemented in a variety of ways, but should be ergonomically comfortable. The Digi-Key corporation sells an assortment of pre-made buttons, but most modern control buttons used for video-games are custom made in order to provide the best ergonomics. The Sony PS2 Dual Shock controller provides one example, but there are numerous others, including entire flexible keyboards.

The motion device circuitry 28 can be implemented with an integrated tri-axial accelerometer, such as the ADXL345, which is a small, thin, low power, 3-axis accelerometer with high resolution (13-bit) measurement at up to ±16 g. The ADXL345 is well suited to measure the static acceleration of gravity in tilt-sensing applications, as well as dynamic acceleration resulting from motion or shock. Its high resolution (4 mg/LSB) enables measurement of inclination changes less than 1.0°. A breakout board SEN-09156 for hobbyists is available from Sparkfun Electronics company. An example of a currently commercially available fully integrated tri-axis accelerometer with wireless communications circuitry is the NikePlus®, which is about the size of a quarter.

Slate computer 18 is best exemplified currently by Apple's iPad®. (Slate computers are sometimes also referred to as tablet computers, though tablets often have keyboards.) This is a fully functional computer which foregoes a traditional keyboard with a touchpad screen. The resulting system is very light and portable, and can easily be carried between fitness machines and placed on the magazine rack. Several slate computers are available (e.g. Apple iPad®, Dell Streak®, Samsung Galaxy®, etc.). They are all capable of running video games, though differences in speed, etc. will exist depending on the specific models. Some type of wireless communications capability is present in all slates, so no extra communications hardware will be necessary in order to communicate with ring push-button control device 14 and motion sensing device 16. An alternative to having a full-blown slate computer is to use a cell phone or headset with built in display capability.

An alternative embodiment to having the game running solely on slate computer 18 is to have the game running on a server on the internet, with the slate used as a “thin client”. This communication with servers on the net is desirable in that it allows multi-player games, saving player health and game score statistics, etc. It is easily implemented using Wi-Fi access to the net.

An extremely wide variety of types of game play are available. It is generally envisioned that user 10 will use ring push-button control devices 14 to perform such actions as turning left and right by depressing buttons on the appropriate hand, perform other actions such as shooting, picking things up, activating special powers, and so on. In order to link the game to the fitness machine it is envisioned that the speed of user 10's character in the game will depend on his/her activity speed on the fitness machine, as sensed by motion sensing device 16. A simple game that might be played this way is PacMan®, but a variety of games, from racing to the most modern first person shooters, are also potentially applicable.

A wide range of speed is possible between the various types of fitness machines that might be employed, such as elliptical trainers, recumbent bikes, rowing machines, and stair steppers. In order to accommodate this user 10 might begin by having the game software ask him/her to set the fitness machine resistance level to something comfortable, and then be asked by the software to go fast for a minute, then slowly for another minute, in order to allow the game software to determine the appropriate ratio between player motion speed and speed of the character in the game.

### CONCLUSION, RAMIFICATIONS, AND SCOPE

Accordingly, the reader will see that the transferable exercise video game system for use with fitness equipment, in the various embodiments, has a number of advantages. The system can be used on any of a variety of machines and is easily changed between them, thereby minimizing the investment necessary in order to convert a normal fitness machine into an exergaming system. The already ubiquitous nature of slate computers and cell phones provides a central component of the system that a user may well own, in which case the only necessary components will be the wireless interface components.

Although the description above contains many specificities, these should not be construed as limiting the scope of the embodiments but as merely providing illustrations of some of several embodiments. For example, the fitness machines used can vary from elliptical trainers to recumbent bike; the slate computer used can be any of a wide variety; the games played can vary from racing to shooters; the buttons and means of attachment can vary from Velcro to buckles, etc. Thus the scope of the embodiments should be determined by the appended claims and their legal equivalents, rather than by the examples given.

I claim:

1. A transferable interface system allowing a video game to be played by a user while exercising on a cardio fitness machine, comprising:
at least one control device worn on at least one of said user's hands, and
at least one sensor capable of sensing the rate of speed of said user's motion, worn on a moving part of said user's body, and
at least one computer/display device.

2. The system of claim 1, wherein said control devices and sensors communicate wirelessly with the computer/display device.

3. The system of claim 1, wherein at least one of said sensors capable of sensing the rate of speed of said user's motion are comprised of an accelerometer and electrical circuitry, with said electrical circuitry allowing the measured quantities of motion to be transmitted as video game control signals.

4. The system of claim 1, with said computer/display device communicating with another computer.

5. The system of claim 1, with an additional heart rate sensor worn by said user, combined with electrical circuitry, with said electrical circuitry allowing said user's heart rate to be transmitted as an input signal to said video game.

6. The system of claim 1, with said computer/display being a cell phone.

7. The system of claim 1, with said computer/display device worn on the head.

8. The system of claim 1, with communication from said computer/display device to the fitness machine.

9. The system of claim 8, with said communication used to change the difficulty settings of the fitness machine.

10. The system of claim 1, where all of the wireless circuitry is in an easily rechargeable form.
